(19) United States
(12) Patent Application Publication
(10) Pub. No.: US 2026/0139749 A1
(43) Pub. Date: May 21, 2026

(54) CHECK VALVE ASSEMBLY

(71) Applicant: Graco Minnesota Inc., Minneapolis, MN (US)

(72) Inventors: Jacob K. Krech, Andover, MN (US); Mark L. Bauck, Coon Rapids, MN (US); Cory J. Haskamp, Isanti, MN (US)

(21) Appl. No.: 19/375,705

(22) Filed: Oct. 31, 2025

Related U.S. Application Data
(60) Provisional application No. 63/723,475, filed on Nov. 21, 2024.

(51) Int. Cl. F16K 15/06

(52) U.S. Cl. CPC F16K 15/063

(57) ABSTRACT

A check assembly is configured to allow flow in a downstream direction while preventing retrograde flow in an upstream direction. A check of the check assembly is disposed within a valve housing of the check assembly. The check interfaces with a seat to place the check assembly in a closed state. The seat is formed by an angled surface that extends both radially outward and axially.

### CROSS-REFERENCE TO RELATED APPLICATION(S)

This application claims priority to U.S. Provisional Application No. 63/723,475 filed November 21, 2024 and entitled “CHECK VALVE ASSEMBLY,” the disclosure of which is hereby incorporated by reference in its entirety.

### BACKGROUND

This disclosure relates to pumping systems. More specifically, this disclosure relates to chemical injection pumps and valving for such pumps.

Chemical injection pumps are used to inject chemicals, such as corrosion inhibitors, defoamer or anti-foamers, detergent, methanol, emulsifiers or de-emulsifiers, among others. The chemical can be injected into a pipeline, such as a gas or oil pipeline, water treatment, and chemical processing. The chemical injection pump can be configured to provide a measured amount ot liquid at a desired application point. Chemical injection pumps are subjected to harsh chemicals and can be disposed in harsh environments.

### SUMMARY

According to an aspect of the present disclosure, a check assembly for a fluid pump includes a valve housing extending along an axis and including an inlet, an outlet, a check chamber disposed between the inlet and the outlet, a feed passage extending between and fluidly connecting the inlet and the check chamber, and an angled surface at least partially defining the check chamber, the angled surface extending radially outward relative to the feed passage and axially away from the feed passage; and a check disposed within the check chamber, the check including a check body having a base and a stem extending from the base and towards the inlet, wherein the angled surface forms a seat and the check is configured to engage the seat with the check assembly in a closed state.

### BRIEF DESCRIPTION OF THE DRAWINGS

FIG. 1 is an exploded view of a pump.

FIG. 2 is a partial cross-sectional view of the pump shown in FIG. 1.

FIG. 3A is an elevational view of an inlet check assembly.

FIG. 3B is a cross-sectional view taken along line B-B in FIG. 3A.

FIG. 4A is an elevational view of an outlet check assembly.

FIG. 4B is a cross-sectional view taken along line B-B in FIG. 4B

### DETAILED DESCRIPTION

This disclosure relates to fluid supply. More specifically, this disclosure relates to systems for pumping fluid, such as pumps for injecting chemicals at desired application points. Pumps according to the disclosure include an inlet check assembly and an outlet check assembly. The inlet check assembly is configured as a one-way valve assembly that allows fluid flow into the pump while preventing retrograde flow to upstream of the pump. The outlet check assembly is configured as a one-way valve assembly that allows fluid flow out of the pump while preventing retrograde flow from downstream of the pump into the pump.

Check assemblies according to the disclosure include a check that is movable within a check housing. The check is configured to engage with a seat to place the valve in a closed state and is disengaged from the seat to place the valve in an open state. The check can support a seal that engages both the check and the seat with the valve in the closed state. The seal can be configured as an annular seal. The seal is configured to annularly engage the seat about the axis of the check assembly.

Check assemblies according to aspects of the disclosure include a housing that defines a flowpath through the check assembly and that can support other components of the check assembly. According to some aspects of the disclosure, the housing includes an upstream portion and a downstream portion. The upstream portion and the downstream portion can be removably connected to each other. Such a connection facilitates easy assembly and disassembly to provide access to the check and other internal components. The entirety of the check assembly is not required to be removed from the pump or fluid line for servicing or cleaning.

Check assemblies according to aspects of the disclosure include a feed passage that is disposed upstream of the check. A sealing interface between the check and the seat is disposed downstream of the feed passage. The seat extends radially outward relative to the feed passage such that the sealing interface between the check and seat has a greater diameter than the feed passage. The check assembly can be configured such that the check does not extend into the feed passage during operation, preventing sticking.

Check assemblies according to aspects of the disclose include an angled surface that extends downstream from an inlet feed passage. The angled surface extends outward, away from the assembly axis such that the flow path through the check assembly widens along the angled surface. The seat of the valve can be formed by the angled surface. The angled surface is disposed such that the check can engage with the angled surface to seal the flowpath through the check assembly and close the valve. The angled surface is further configured to prevent the check from becoming stuck in place by high pressure fluid when the check is in the closed position. The contact area at the sealing interface between the check and the angled surface forming the seat prevents material deformation and wear due to high checking pressures.

Check assemblies according to aspects of the disclosure may be biased to a closed state. The check assembly can include a biaser, such as a spring, that biases the valve to a closed state. The spring interfaces with the check to bias the check towards the seat.

Components can be considered to radially overlap when those components are disposed at common axial locations along an axis and such that a line extending radially from the axis will extend through each of the radially overlapping components. Components can be considered to axially overlap when those components are disposed at common radial and circumferential locations relative to an axis such that an axial line parallel to the axis extends through each of the axially overlapping components. Components can be considered to circumferentially overlap when aligned about the axis at a common radial distance from the axis such that a circle centered on the axis passes through each of the circumferentially overlapping components.

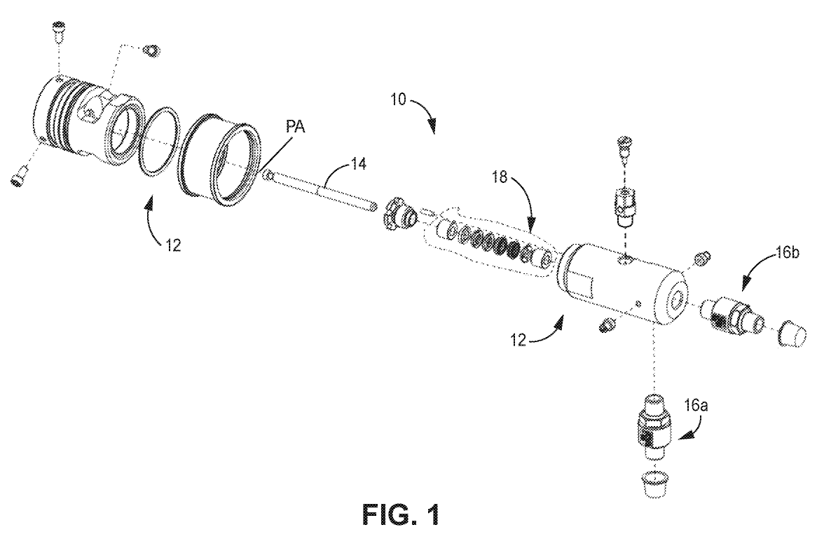

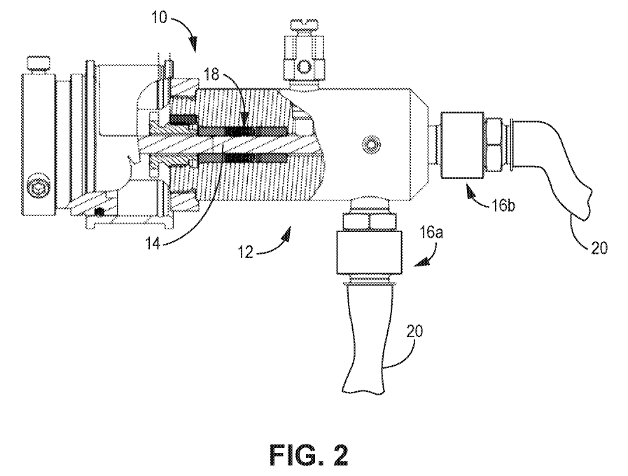

FIG. 1 is an exploded view of pump 10. FIG. 2 is a partial cross-sectional view of pump 10. FIGS. 1 and 2 are discussed together. Pump 10 is configured as a positive displacement pump. Pump 10 includes pump body 12, piston 14, check assembly 16a and check assembly 16b. Piston 14 is at least partially disposed within pump body 12. Piston 14 is configured to reciprocate on a pump axis PA to pump the fluid through a fluid chamber within pump body 12. Piston 14 interfaces with seal assembly 18 and is configured to reciprocate relative to the seal assembly 18. A drive (not shown) is connected to the piston 14 to reciprocate the piston 14. For example, the drive can be an electric drive, a pneumatic drive, a hydraulic drive among other options. The drive can be formed as a motor. The check assemblies 16a, 16b are mounted to pump body 12. Check assemblies 16a, 16b are configured to regulate fluid flow into and out of the fluid chamber of the pump 10. In the example shown, the check assembly 16a forms an inlet valve assembly that regulates flow into the fluid chamber of the pump 10, while check assembly 16b forms an outlet valve assembly that regulates flow out of the fluid chamber of the pump 10. Inlet and outlet hoses 20 are shown in FIG. 2. The inlet hose 20 connects to check assembly 16a to provide fluid to pump 10. The outlet hose 20 connects to check assembly 16b to receive fluid from pump 10.

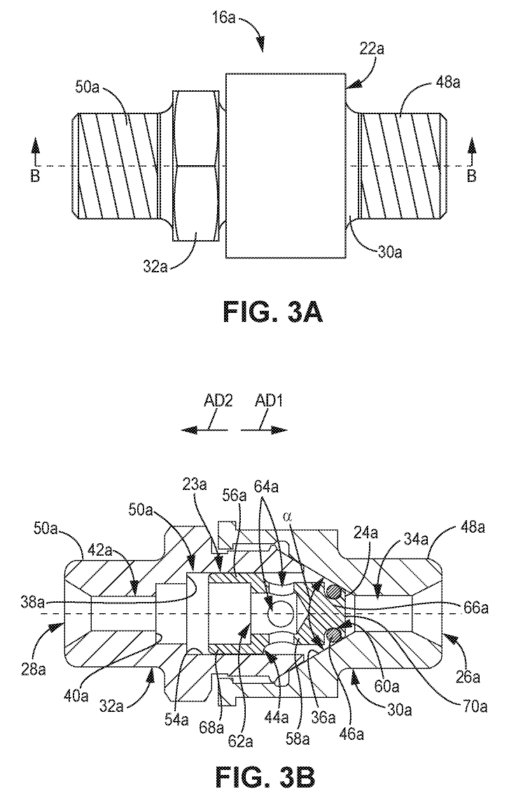

FIG. 3A is an elevational view of check assembly 16a. FIG. 3B is a cross-sectional view taken along line B-B in FIG. 3A. FIGS. 3A and 3B are discussed together. Check assembly 16a includes valve housing 22a, check 23a, seat 24a, inlet 26a, and outlet 28a. Valve housing 22a includes upstream housing 30a and downstream housing 32a. Upstream housing 30a includes feed passage 34a and angled surface 36a. Downstream housing 32a includes brace 38a, shoulder 40a, and outlet passage 42a. Check 23a includes check body 44a and seal 46a.

Check assembly 16a is configured as a one-way check valve that allows fluid flow in the downstream direction AD2 while preventing retrograde flow in the upstream direction AD1. Check assembly 16a is configured for use in chemical injection pumps (e.g., pump 10), but it is understood that the aspects discussed herein are not limited to such pumps. Check assembly 16a is configured as an inlet valve assembly that controls fluid flow into the pump 10 in this example.

Valve housing 22a supports and/or encloses other components of check assembly 16a. Valve housing 22a extends along assembly axis A. Valve housing 22a includes upstream housing 30a and downstream housing 32a that are connected together. In the example shown, the upstream housing 30a and downstream housing 32a are removably connected to each other. For example, the upstream housing 30a and downstream housing 32b can be connected by interfaced threading, among other connection types. In the example shown, the downstream housing 32a extends into the upstream housing 30a to connect to the upstream housing 30a.

Inlet 26a is formed at an outer axial end of upstream housing 30a. Fluid enters into check assembly 16a through inlet 26a. Feed passage 34a is disposed in upstream housing 30a and extends in the downstream direction AD2 from inlet 26a. Feed passage 34a forms a smallest diameter portion of the flowpath through upstream housing 30a in this example.

Angled surface 36a is formed within upstream housing 30a. Angled surface 36a extends in the downstream direction AD2 from feed passage 34a. Angled surface 36a extends both axially and radially relative to feed passage 34a such that the flowpath through check assembly 16a widens along angled surface 36a as the flowpath extends downstream from feed passage 34a. Angled surface 36a can be considered to be frustoconical. Angle α is formed between the walls of the angled surface 36a. Angle α can be between about 50-degrees and about 70-degrees. in some examples, angle α can be between about 55-degrees and about 65-degrees. In some examples, the angle α can be about 60-degrees.

Upstream housing 30a includes upstream mount 48a that facilitates connection of upstream housing 30a with other components of a pumping system, such as with a supply hose. In the example shown, upstream mount 48a is formed by exterior threading on upstream housing 30a. It is understood, however, that upstream mount 48a can be of any suitable configuration for forming such a connection.

Downstream housing 32a is connected to upstream housing 30a. Outlet 28a is formed at an outer axial end of downstream housing 32a. Fluid exits from check assembly 16a through outlet 28a. Outlet passage 42a is disposed in downstream housing 32 and extends in the upstream direction AD1 from the outlet 28. Outlet passage 42a forms a smallest diameter portion of the flowpath through downstream housing 32a in this example. Shoulder 40a extends radially outward from an upstream end of outlet passage 42a. Shoulder 40a can project radially such that the axially oriented surface of shoulder 40a is disposed perpendicular to the axially oriented surface of outlet passage 42a. Brace 38a extends radially outward relative to the radially outer side of shoulder 40a. Brace 38a is configured to limit a downstream extent of travel for the check 23a, as discussed in more detail below. The brace 38a extends radially to axially overlap with a downstream end of check 23a.

Downstream housing 32a includes downstream mount 50a that facilitates connection of downstream housing 32a with other components of a pumping system, such as with an outlet hose. In the example shown, downstream mount 50a is formed by exterior threading on downstream housing 32a. It is understood, however, that downstream mount 50a can be of any suitable configuration for forming such a connection.

Check 23a is disposed within valve housing 22a. Check 23a is configured to move within check chamber 52 disposed within valve housing 22a. In the example shown, the check chamber 52 is defined by both the upstream housing 30a and the downstream housing 32a. The angled surface 36a defines an upstream end of the check chamber 52a as the angled surface 36a limits movement of the check 23a in the upstream direction AD1. The brace 38a defines a downstream end of the check chamber 52a as the brace 38a limits movement of the check 23a in the downstream direction AD1.

Check 23a is movable along assembly axis A towards and away from seat 24a. Seat 24a is formed by valve housing 22a. Seat 24a is formed by upstream housing 30a in this example. Seat 24a is formed by angled surface 36a in the example shown.

Check body 44a is disposed within check chamber 52a. Check body 44a can, in some examples, engage with one or more surfaces defining the radial edge of check chamber 52a. For example, the outer surface of the check body 44a can ride along the chamber surface 54a that forms the inner surface of a portion of valve housing 22a defining the radial outer side of the check chamber 52a. The chamber surface 54a can be considered to form a guide surface that maintains alignment of the check 23a with the seat 24a during movement of the check 23a.

Check body 44a includes base 56a and stem 58a. Base 56a is disposed at a downstream end of check 23a and stem 58a extends in the upstream direction AD1 from base 56a. Base 56a has a greater width that stem 58a. Base 56a can have a larger diameter than stem 58a. In the example shown, the base 56a can ride along the chamber surface 54a such that check 23a is guided axially by such engagement. The base 56a axially overlaps with brace 38a such that engagement between brace 38a and base 56a limits movement of the check 23a in the downstream direction AD2.

Stem 58a extends axially from base 56a. Stem 58a extends towards seat 24a. Stem 58a extends towards inlet 26a. Check 23a is configured to engage with seat 24a to place check assembly 16a in a closed state. In the example shown, the check 23a includes seal 46a that engages with seat 24a to place check assembly 16a in the closed state. Seal 46a can be an elastomeric seal, such as an o-ring, among other options. Seal 46a can extend fully annularly about the axis A to form a full annular seal with seat 24a when check assembly 16a is in the closed state. In the example shown, the seal 46a is supported by the check 23a and is configured to move with the check 23a. Seal 46a is disposed in seal groove 60a on stem 58a. In some examples, seal 46a is configured to interface with seat 24a while the material forming the check body 44a does not contact the seat 24a, though it is understood that not all examples are so limited.

Check 23a extends between an upstream end 66a and a downstream end 68a. The downstream end 68 is formed by base 56a and the upstream end 66a is formed by stem 58a. Check face 70a is disposed at a distal end of the stem 58a and is oriented in the upstream direction AD1. The check face 70a has a smaller diameter than the portions of stem 58a disposed downstream of seal groove 60. The seal groove 60 is configured such that seal 46 is exposed in both the upstream axial direction AD1 and radially outward from the axis A, which configuration facilitates sealing with the angled surface 36a forming seat 24a.

The flowpath through check assembly 16a is disposed at least partially within check 23a. Check passage 62a is disposed within check 23a. Check passage 62a is open axially in the downstream direction AD2. Check passage 62a is partially disposed in base 56a and partially disposed in stem 58a. Apertures 64a extend through check 23a and are in fluid communication with check passage 62a. Apertures 64a are formed through stem 58a in this example. While check 23a is shown as including a plurality of the apertures 64a, it is understood that check 23a can include any desired number of apertures 64a, such as one, two, three, four, etc. In examples in which check 23a includes a plurality of the apertures 64a, such apertures 64a can be arrayed about the axis A. Such apertures 64a can be evenly arrayed about the axis A in various examples.

During operation, fluid enters into check assembly 16a through inlet 26 and exits from check assembly 16a through outlet 28a. With check assembly 16a in an open state, the fluid is able to flow into the check chamber 52a between check 23a and seat 24a, then flow through apertures 64a into check passage 62a, and then flow downstream from check passage 62a to outlet 28. With check assembly 16a in a closed state, the sealing interface between check 23a and seat 24a (e.g., between seal 46a and seat 24a) prevents fluid from flowing into check chamber 52a from inlet 26a and feed passage 34a.

Fluid flow through the upstream housing 30a creates a pressure differential on the check 23a that forces the check 23a to move in the downstream direction AD2 to open the check assembly 16a. Check 23a disengages from seat 24a and fluid can flow to outlet 28a from inlet 26a. Pressure differential in the opposite direction (e.g., such as due to pumping by pump 10) causes the check 23a to move in the upstream direction AD1 to engage check 23a with seat 24a and close check assembly 16a, preventing flow from outlet 28a to inlet 26a.

Check assembly 16a is configured such that the check 23a is prevented from passing into the feed passage 34a. Check 23a does not enter into feed passage 34a. The upstream end 66a of check 23a is spaced in a downstream direction from the feed passage 34a with the check assembly 16a in a closed state. The diameter of the sealing interface (i.e., location seal 46a engages with seat 24a) is greater than the diameter of the feed passage 34a. In the example shown, a smallest diameter of the check 23a is larger than a largest diameter of the feed passage 34a. Preventing the check 23a from entering into the feed passage 34a provides for a more robust configuration that prevents sticking of the check 23a. The check 23a is prevented from becoming stuck in place by high pressure fluid when the check assembly 16a is in the closed state.

In the example shown, the check 23a is not biased towards positions associated with either a closed state or an open state of the check assembly 16a. Check assembly 16a does not include a spring. Check assembly 16a does not include a spring within or outside of the fluid flow through check assembly 16a. In examples in which check assembly 16a is configured as an inlet valve for a pump, the check assembly 16a not including a spring provides for improved priming of the pump 10 as the pressure differential to open check assembly 16a does not also have to overcome the biasing force of any spring.

Angled surface 36a forms seat 24a and is disposed at angle α. The angle α is between about 50-degrees to about 70-degrees. More specifically, the angle α can be between about 55-degrees and about 65-degrees. In some examples, the angle α is about 60-degrees. The angle α of angled surface 36a prevents sticking of the check 23a while also preventing material deformation and wear due to high checking pressures. The angle α of the angled surface 36a facilitates smooth actuation of the check 23a while combating wear, providing for robust, reliable check valving. If the angle α is too acute, then the check 23a may become stuck, whereas if the angle α is too obtuse, the bearing stresses increase leading to increased wear on the components of check assembly 16a.

Upstream housing 30a is connected to downstream housing 32a to form valve housing 22a. The multi-part valve housing 22a allows for disassembly of valve housing 22a to provide access to internal components of check assembly 16. Disconnecting upstream housing 30a and downstream housing 32a provides access to the check 23a, seal 46a, and internal surfaces of the upstream housing 30a and downstream housing 32a. The user can thereby access the internal components of check assembly 16a without having to remove the entirety of check assembly 16a from the pump or fluid line for servicing and/or cleaning.

Check 23a is fully retained within valve housing 22a by internal features of the valve housing 22a (e.g., brace 38a and angled surface 36a for axial retention). The check assembly 16a does not include a separate check retainer that has to be removed in order to access the check 23a. Instead, the upstream housing 30a and downstream housing 32a can be disconnected and the check 23a can be removed from the upstream housing 30a in downstream direction AD2 or removed from the downstream housing 32a in upstream direction AD1. The check 23a being fully retained in valve housing 22a by internal features of valve housing 22a simplifies the configuration of check assembly 16a, reduces part count, and provides for simpler, easier, and quicker servicing, thereby reducing downtime and cost.

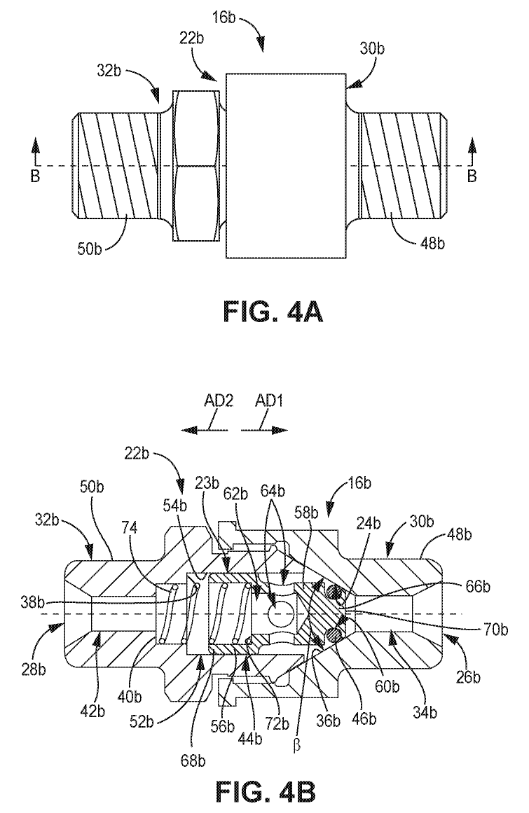

FIG. 4A is an elevational view of check assembly 16b. FIG. 4B is a cross-sectional view taken along line B-B in FIG. 4A. FIGS. 4A and 4B are discussed together. Check assembly 16b includes valve housing 22b, check 23b, seat 24b, inlet 26b, outlet 28b, and spring 74. Valve housing 22b includes upstream housing 30b and downstream housing 32b. Upstream housing 30b includes feed passage 34b and angled surface 36b. Downstream housing 32b includes brace 38b, shoulder 40b, and outlet passage 42b. Check 23b includes check body 44b, check stem 58b, apertures 64b, and seal 46b. Components of check assembly 16b are substantively similar to components of check assembly 16a, with like components indicated with the same reference numeral except with a “b” instead of an “a” (e.g., check 23a and check 23b).

Check assembly 16b is configured as a one-way check valve that allows fluid flow in the downstream direction AD2 while preventing retrograde flow in the upstream direction AD1. Check assembly 16b is configured for use in chemical injection pumps (e.g., pump 10), but it is understood that the aspects discussed herein are not limited to such pumps. Check assembly 16b is configured as an outlet valve assembly that controls fluid flow out from the pump 10 in this example.

Valve housing 22b supports and/or encloses other components of check assembly 16b. Valve housing 22b extends along assembly axis A. Valve housing 22b includes upstream housing 30b and downstream housing 32b that are connected together. In the example shown, the upstream housing 30b and downstream housing 32b are removably connected to each other. For example, the upstream housing 30b and downstream housing 32b can be connected by interfaced threading, among other connection types.

Inlet 26b is formed at an outer axial end of upstream housing 30b. Fluid enters into check assembly 16b through inlet 26b. Feed passage 34b is disposed in upstream housing 30b and extends in the downstream direction AD2 from inlet 26b. Feed passage 34b forms a smallest diameter portion of the flowpath through upstream housing 30b in this example.

Angled surface 36b is formed within upstream housing 30b. Angled surface 36b extends in the downstream direction AD2 from feed passage 34b. Angled surface 36b extends both axially and radially relative to feed passage 34b such that the flowpath through check assembly 16b widens along angled surface 36b. Angled surface 36b can be considered to be frustoconical. Angle β is formed between the walls of the angled surface 36b. Angle β can be between about 50-degrees and about 70-degrees. In some examples, angle β can be between about 55-degrees and about 65-degrees. In some examples, the angle β can be about 60-degrees.

Upstream housing 30b includes upstream mount 48b that facilitates connection of upstream housing 30b with other components of a pumping system, such as with the pump 10. In the example shown, upstream mount 48b is formed by exterior threading on upstream housing 30b. It is understood, however, that upstream mount 48b can be of any suitable configuration for forming such a connection.

Downstream housing 32b is connected to upstream housing 30b. Outlet 28b is formed at an outer axial end of downstream housing 32b. Fluid exits from check assembly 16b through outlet 28b. Outlet passage 42b is disposed in downstream housing 32 and extends in the upstream direction AD1 from the outlet 28. Outlet passage 42b forms a smallest diameter portion of the flowpath through downstream housing 32b in this example.

Downstream housing 32b includes downstream mount 50a that facilitates connection of downstream housing 32b with other components of a pumping system, such as with an outlet hose. In the example shown, downstream mount 50b is formed by exterior threading on downstream housing 32b. It is understood, however, that downstream mount 50b can be of any suitable configuration for forming such a connection.

Shoulder 40b extends radially outward from an upstream end of outlet passage 42b. Shoulder 40b can project radially such that the axially oriented surface of shoulder 40b is disposed perpendicular to the axially oriented surface of outlet passage 42b. Shoulder 40b interfaces with spring 74 and is configured to brace spring 74.

Brace 38b extends radially outward relative to the radially outer side of shoulder 40b. Brace 38b is configured to limit a downstream extent of travel for the check 23b, as discussed in more detail below. The brace 38b extends radially outward to axially overlap with a downstream end of check 23b.

Check 23b is disposed within valve housing 22b. Check 23b is configured to move within check chamber 52 disposed within valve housing 22b. In the example shown, the check chamber 52 is defined by both the upstream housing 30b and the downstream housing 32b. The angled surface 36b defines an upstream end of the check chamber 52b as the angled surface 36b limits movement of the check 23b in the upstream direction AD1. The brace 38b defines a downstream end of the check chamber 52b as the brace 38b limits movement of the check 23b in the downstream direction AD1.

Check 23b is movable along assembly axis A towards and away from seat 24b. Seat 24b is formed by valve housing 22b. Seat 24b is formed by upstream housing 30b in this example. Seat 24b is formed by angled surface 36b in the example shown.

Check body 44b is disposed within check chamber 52b. Check body 44b can, in some examples, engage with one or more surfaces defining the radial edge of check chamber 52b. For example, the outer surface of the check body 44b can ride along the inner surface of a portion of valve housing 22b defining the radial outer side of the check chamber 52b. The chamber surface 54b can be considered to form a guide surface that maintains alignment of the check 23b with the seat 24b during movement of the check 23b.

Check body 44b includes base 56b and stem 58b. Base 56b is disposed at a downstream end of check 23b and stem 58b extends in the upstream direction AD1 from base 56b. Base 56b has a greater width that stem 58b. Base 56b can have a larger diameter than stem 58b. In the example shown, the base 56b can ride along the chamber surface 54b such that check 23b is guided axially by such engagement. The base 56b axially overlaps with brace 38b such that engagement between brace 38b and base 56b limits movement of the check 23b in the downstream direction AD2.

Stem 58b extends axially from base 56b. Stem 58b extends towards seat 24b. Stem 58b extends towards inlet 26b. Check 23b is configured to engage with seat 24b to place check assembly 16b in a closed state. In the example shown, the check 23b includes seal 46b that engages with seat 24b to place check assembly 16b in the closed state. Seal 46b can be an elastomeric seal, such as an o-ring, among other options. Seal 46b can extend fully annularly about the axis A to form a full annular seal with seat 24b when check assembly 16b is in the closed state. In the example shown, the seal 46b is supported by the check 23b and is configured to move with the check 23b. Seal 46b is disposed in seal groove 60b on stem 58b. In some examples, seal 46b is configured to interface with seat 24b while the material forming the check body 44b does not contact the seat 24b, though it is understood that not all examples are so limited.

Check passage 62b is disposed within check 23b. Check passage 62b is open axially in the downstream direction AD2. Check passage 62b is partially disposed in base 56b and partially disposed in stem 58b. Apertures 64b extend through check 23b and are in fluid communication with check passage 62b. Apertures 64b are formed through stem 58b in this example. While check 23b is shown as including a plurality of the apertures 64b, it is understood that check 23b can include any desired number of apertures 64b, such as one, two, three, four, etc. In examples in which check 23b includes a plurality of the apertures 64b, such apertures 64b can be arrayed about the axis A. Such apertures 64b can be evenly arrayed about the axis A in various examples.

Spring 74 is disposed in valve housing 22 and interfaces with check 23b. Spring 74 is configured to bias check assembly 16b to a closed state. The spring 74 biases the check 23b in the upstream direction AD1 and towards engagement with the seat 24b such that check assembly 16b is normally closed. In the example shown, spring 74 interfaces with shoulder 40 on a downstream end of spring 74 and spring 74 interfaces with check 23b at an upstream end of spring 74. The spring 74 extends into the check 23 in this example. The spring 74 extends into check body 44b through the downstream opening of the check passage 62b. The spring 74 extends into the base 56b of check 23b in the example shown. The spring 74 extends such that the spring 74 radially overlaps with check body 44b. Spring 74 extending into check body 44 provides alignment between spring 74 and check body 44 and alignment on axis A.

During operation, fluid enters into check assembly 16b through inlet 26 and exits from check assembly 16b through outlet 28b. With check assembly 16b in an open state, the fluid is able to flow into the check chamber 52b between check 23b and seat 24b, then flow through apertures 64b into check passage 62b, and then flow downstream from check passage 62b to outlet 28. With check assembly 16b in a closed state, the sealing interface between check 23b and seat 24b (e.g., between seal 46b and seat 24b) prevents fluid from flowing into check chamber 52b from inlet 26b and feed passage 34b. The spring 74 assists in maintaining check assembly 16b in the closed state.

Fluid flow through the upstream housing 30b creates a pressure differential on the check 23b that overcomes the spring force of the spring 74 and forces the check 23b to move in the downstream direction AD2 to open the check assembly 16b. Check 23b disengages from seat 24b and fluid can flow to outlet 28b from inlet 26b. Spring 74 is compressed between brace 38b and check body 44b. Pressure differential in the opposite direction (e.g., such as due to pumping by pump 10) causes the check 23b to move in the upstream direction AD1 to engage check 23b with seat 24b and close check assembly 16b, preventing flow from outlet 28b to inlet 26b. Spring 74 can also assist in closing of check assembly 16b by biasing check 23b into engagement with seat 24b.

Check assembly 16b is configured such that the check 23b is prevented from passing into the feed passage 34b. Check 23b does not enter into feed passage 34b. The upstream end 66b of check 23b is spaced in a downstream direction from the feed passage 34b with the check assembly 16b in a closed state. The diameter of the sealing interface (i.e., location seal 46b engages with seat 24b) is greater than the diameter of the feed passage 34b. In the example shown, a smallest diameter of the check 23b is larger than a largest diameter of the feed passage 34b. Preventing the check 23b from entering into the feed passage 34b provides for a more robust configuration that prevents sticking of the check 23b. The check 23b is prevented from becoming stuck in place by high pressure fluid when the check assembly 16b is in the closed state.

In the example shown, the check 23b is biased towards the position associated with the closed state of the check assembly 16b. In examples in which check assembly 16b is configured as an outlet valve for a pump, the check assembly 16b including spring 74 provides for improved check assembly 16b and pump 10 efficiency. The spring 74 can facilitate quicker closing of the check assembly 16b as compared to a check assembly that does not include a spring 74. The quicker closure of the check assembly 16b can assist in reducing pressure drop during such closure, providing more efficient operation.

Spring 74 is disposed within valve housing 22. Spring 74 interfaces with check 23b and with valve housing 22b to bias check 23b. In the example shown, spring 74 extends between shoulder 40b of valve housing 22b and check shoulder 72b internal to check 23b. Spring 74b extends downstream of a downstream limit of travel of check 23b in this example.

Angled surface 36b forms seat 24b and is disposed at angle β. The angle β can be between about 50-degrees and about 70-degrees. More specifically, the angle β can be between about 55-degrees and about 65-degrees. In some examples, the angle β is about 60-degrees. The angle β of angled surface 36b prevents sticking of the check 23b while also preventing material deformation and wear due to high checking pressures. The angle β of the angled surface 36b facilitates smooth actuation of the check 23b while combating wear, providing for robust, reliable check valving. If the angle β is too acute, then the check 23b may become stuck, whereas if the angle β is too obtuse, the bearing stresses increase leading to increased wear on the components of check assembly 16b.

Upstream housing 30b is connected to downstream housing 32b to form valve housing 22b. The multi-part valve housing 22b allows for disassembly of valve housing 22b to provide access to internal components of check assembly 16. Disconnecting upstream housing 30b and downstream housing 32b provides access to the check 23b, seal 46b, and internal surfaces of the upstream housing 30b and downstream housing 32b. The user can thereby access the internal components of check assembly 16b without having to remove the entirety of check assembly 16b from the pump or fluid line for servicing and/or cleaning. The check 23b is fully retained within valve housing 22b by internal features of the valve housing 22b (e.g., brace 38b and angled surface 36b for axial retention). The check assembly 16b does not include a separate check retainer that has to be removed in order to access the check 23b. Instead, the upstream housing 30b and downstream housing 32b can be disconnected and the check 23b can be removed from the upstream housing 30b in downstream direction AD2 or removed from the downstream housing 32b in upstream direction AD1. The check 23b being fully retained in valve housing 22b by internal features of valve housing 22b simplifies the configuration of check assembly 16b, reduces part count, and provides for simpler, easier, and quicker servicing, thereby reducing downtime and cost.

Referring to FIG. 3A–4B, the configuration of the check assemblies 16a, 16b facilitate efficient operation of a pump and provide reduced downtime for servicing, cleaning, and/or replacement. In some examples, check assembly 16a is the same as check assembly 16b except that check assembly 16b includes spring 74 that biases check assembly 16b to the closed state. In such an example, the checks 23a, 23b can be the same and the valve housings 22a, 22b can be the same. Such a configuration can provide for ease of operation and assembly by a user. A check assembly 16a, 16b can quickly and easily be converted for use as an inlet check assembly by removal of a spring 74 or can quickly and easily be converted for use as an outlet check assembly by addition of a spring 74. A check 23a, 23b can be replaced with the same check structure regardless of whether in an inlet or outlet check assembly.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A check assembly for a fluid pump, the check assembly comprising:
a valve housing extending along an axis and including an inlet, an outlet, a check chamber disposed between the inlet and the outlet, a feed passage extending between and fluidly connecting the inlet and the check chamber, and an angled surface at least partially defining the check chamber, the angled surface extending radially outward relative to the feed passage and axially away from the feed passage; and
a check disposed within the check chamber, the check including a check body having a base and a stem extending from the base and towards the inlet, wherein the angled surface forms a seat and the check is configured to engage the seat with the check assembly in a closed state.

2. The check assembly of claim 1, wherein the angled surface is disposed at a first angle relative to the axis, the first angle between 50-degrees and about 70-degrees.

3. The check assembly of claim 2, wherein the first angle is about 60-degrees.

4. The check assembly of claim 1, wherein a width of the stem is greater than a width of the feed passage such that the stem is prevented from entering into the feed passage.

5. The check assembly of claim 1, wherein a portion of a flowpath between the inlet and the outlet is at least partially disposed within the check.

6. The check assembly of claim 5, wherein a check passage is disposed within the check, the check passage open axially towards the outlet.

7. The check assembly of claim 5, wherein at least one aperture extends through the check to provide a flowpath for fluid to flow into the check from outside of the check.

8. The check assembly of claim 7, wherein the at least one aperture includes a plurality of apertures.

9. The check assembly of claim 8, wherein the plurality of apertures are evenly arrayed about the axis.

10. The check assembly of claim 1, further comprising:
a brace that axially overlaps with a downstream end of the check, the brace limiting movement of the check towards the outlet.

11. The check assembly of claim 1, wherein the check further comprises:
a seal mounted on the check body.

12. The check assembly of claim 11, wherein the seal is mounted on the stem.

13. The check assembly of claim 12, wherein the seal engages the angled surface with the check assembly in the closed state.

14. The check assembly of claim 1, further comprising:
a spring biasing the check towards the seat.

15. The check assembly of claim 14, wherein the spring is at least partially disposed within the check.

16. The check assembly of claim 14, wherein the spring extends downstream of a downstream limit of travel of the check.

17. The check assembly of claim 14, wherein the spring extends between a first shoulder formed by the valve housing and a second shoulder disposed within the check.

18. The check assembly of claim 1, wherein the valve housing includes an upstream housing connected to a downstream housing.

19. The check assembly of claim 18, wherein the upstream housing is connected to the downstream housing by interfaced threading.

20. The check assembly of claim 18, wherein the check is at least partially disposed within the upstream housing and at least partially disposed within the downstream housing.
